(19) United States
(12) Patent Application Publication
(10) Pub. No.: US 2013/0081073 A1
(43) Pub. Date: Mar. 28, 2013

(54) METHOD AND APPARATUS FOR PROVIDING AND OBTAINING REWARD SERVICE LINKED WITH MEDIA CONTENTS

(71) Applicant: Samsung Electronics Co., Ltd., Gyeonggi-do (KR)

(72) Inventors: Sangwook KANG, Gyeonggi-do (KR); Donghun Park, Gyeonggi-do (KR); Wonho Ryu, Gyeonggi-do (KR)

(73) Assignee: Samsung Electronics Co., Ltd., Gyeonggi-do (KR)

(21) Appl. No.: 13/629,057

(22) Filed: Sep. 27, 2012

(30) Foreign Application Priority Data
Sep. 28, 2011 (KR) 10-2011-0098518

(51) Int. Cl. H04N 21/442

(52) U.S. Cl. 725/14

(57) ABSTRACT

Provided are a method and apparatus for providing and obtaining a reward service linked with media contents. The method includes transmitting reward service information linked with the media contents to a user device, receiving check-in information authenticating that certain media contents are being played, determining whether a provision condition of the reward service is satisfied, and granting a use right with respect to the reward service to the user device when the provision condition of the reward service is satisfied. Herein, user utility with respect to media contents are improved and user information of the media contents are collected.

### PRIORITY

This application claims priority under 35 U.S.C. §119(a) to Korean Patent Application Serial No. 10-2011-0098518, which was filed in the Korean Intellectual Property Office on Sep. 28, 2011, the content of which is incorporated herein by reference.

### BACKGROUND OF THE INVENTION

1. Field of the Invention

The present invention relates generally to a method and apparatus for providing and obtaining a reward service linked with media contents, and more particularly, to a method and apparatus for providing and obtaining a reward service by using check-in information which authenticates that a user is playing certain media contents as a condition.

2. Description of the Related Art

A check-in function has rapidly evolved with the development of the Social Network Service (SNS). Examples of the check-in function are Foursquare, Google® latitude and Facebook® place. These generally use a location-based check-in function. The check-in opens a current location according to a user selection. For example, Facebook Deals pre-registers a service that a shop of a certain location will provide, and allots the foregoing service to a user who checks-in the shop.

However, such services only have check-in based on location through a Global Positioning System (GPS) as a target. A larger market should be formed if the user collects check-in information based on media contents. For example, an advertiser may directly advertise products to a viewer to activate an advertising market. In the meantime, a broadcasting system may reward a viewer checking-in corresponding media contents to introduce viewing of certain media contents. The viewer may transmit check-in information to attempt a new communication with the advertiser and broadcasting system, which induces check-in and user utility with respect to the media contents, and the collection of user information of the media contents.

Accordingly, there is a need for a method and an apparatus for providing and obtaining a reward service linked with media contents using check-in information authenticating that the user is playing certain media contents as a condition.

### SUMMARY OF THE INVENTION

The present invention has been made in view of the above problems, and provides a method and an apparatus for providing and obtaining a reward service linked with media contents using check-in information authenticating that the user is playing certain media contents as a condition.

In accordance with an aspect of the present invention, a method for providing a reward service linked with media contents includes transmitting reward service information linked with the media contents to a user device, receiving check-in information authenticating that certain media contents are being played from the user device, determining whether a provision condition of the reward service is satisfied by the user device, and granting a use right with respect to the reward service to the user device when the provision condition of the reward service is satisfied, wherein the provision condition of the reward service is reception of the check-in information.

In accordance with another aspect of the present invention, a platform server for providing a reward service linked with media contents includes a communication unit transmitting reward service information linked with the media contents and receiving check-in information authenticating that the media contents are being played, a memory storing the reward service information, the check-in information, and a profile of a user device, and a controller controlling such that the reward service information is transmitted to the user device, collecting the check-in information, determining whether the user device satisfies a provision condition of the reward service, and granting a use right with respect to the reward service to the user device when the user device satisfies the provision condition of the reward service, wherein the provision condition of the reward service is reception of the check-in information.

In accordance with another aspect of the present invention, a method for obtaining a reward service linked with media contents includes receiving and displaying reward service information linked with the media contents, receiving and transmitting check-in information authenticating that certain media contents are being played to a platform server, and receiving a use right with the reward service from the platform server when an obtaining condition of the reward service is satisfied, wherein the obtaining condition of the reward service is satisfied.

In accordance with another aspect of the present invention, a user device for obtaining a reward service linked with media contents includes a communication unit transmitting reward service information linked with the media contents and receiving check-in information authenticating that the media contents are being played, a display unit displaying the reward service information; an input unit inputting the check-in information, a memory storing the reward service information and the check-in information, and a controller controlling such that the reward service information is displayed, and obtaining a use right with respect to the reward service from the platform server when an obtaining condition of the reward service is satisfied, wherein the obtaining condition of the reward service is transmission of the check-in information.

### BRIEF DESCRIPTION OF THE DRAWINGS

The objects, features and advantages of the present invention will be more apparent from the following detailed description in conjunction with the accompanying drawings, in which:

FIG. 1 illustrates a system for providing and obtaining a reward service linked with media contents according to an embodiment of the present invention;

FIG. 2 illustrates a platform server providing a reward service linked with media contents according to an embodiment of the present invention;

FIG. 3 illustrates a user device for obtaining a reward service linked with media contents according to an embodiment of the present invention;

FIG. 4 illustrates a method for providing and obtaining a reward service linked with media contents according to an embodiment of the present invention;

FIG. 5 illustrates a procedure of providing a reward service linked with media contents by a platform server;

FIG. 6 illustrates a procedure of obtaining a reward service linked with media contents by a user device; and

FIG. 7 illustrates a method displaying a reward service linked with media contents.

### DETAILED DESCRIPTION OF EMBODIMENTS OF THE INVENTION

Embodiments of the present invention are described with reference to the accompanying drawings in detail. The same reference numbers are used throughout the drawings to refer to the same or like parts. Detailed descriptions of well-known functions and structures incorporated herein may be omitted for the sake of clarity and conciseness.

As used herein, the term “media contents check-in” indicates authenticating that a user is playing certain media contents and opening corresponding information. Such a check-in is premised on this opening, unlike login information. For example, the check-in indicates a separate input for authenticating a user, such as clicking an icon. As used herein, the term “media contents check-in” includes moving images, texts, and voices, and digital or analog based playable contents.

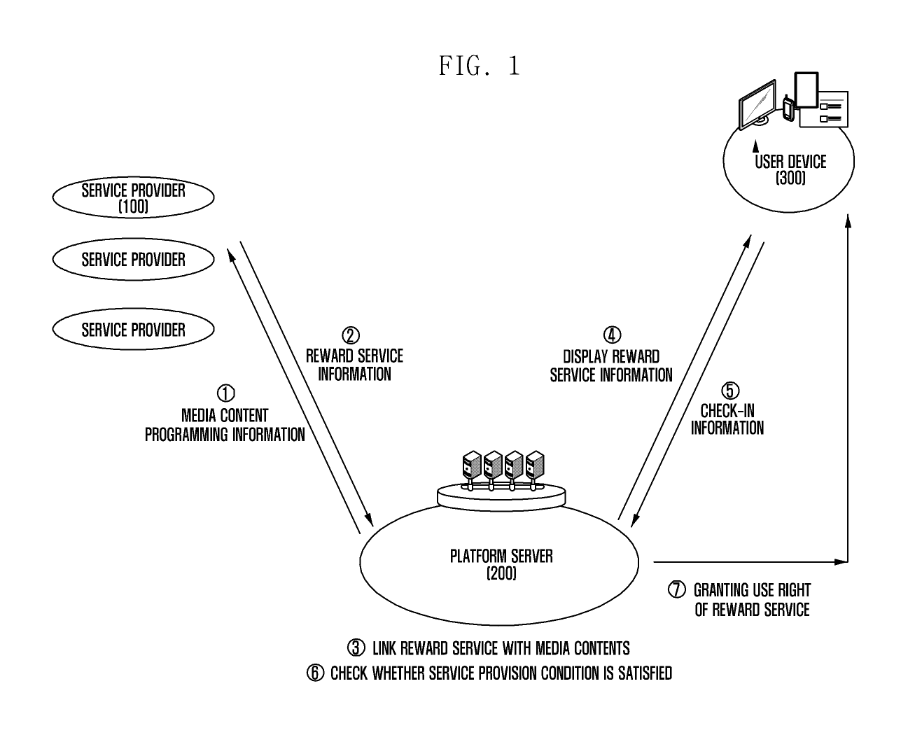

FIG. 1 illustrates a system for providing and obtaining a reward service linked with media contents according to an embodiment of the present invention. As shown in FIG. 1, a plurality of providers 100 and a plurality of user devices 300 are connected to each other through a platform server 200, which includes a web site server or an Internet TV providing server providing media contents. The user device 300 indicates devices allowing a user to share information through a platform server 200, such as a portable phone, a Personal Digital Assistant (PDA), a computer or a Motion Pictures Experts Group (MPEG)-Layer Audio 3 (MP3) player. A plurality of user devices 300 and a platform server 200 may be connected with each other in a wired or wireless scheme.

The platform server 200 provides programming information of media contents to service providers. When a list of media contents included in the platform server 200 and the media contents are transmitted to a user, the programming information may contain a transmission time and information regarding media contents by time units dividing a total playback time of the media contents.

The service provider 100 then provides information with respect to a reward service linked with certain media contents based on programming information of the media contents. The reward service information may include a title of media contents to be linked, a detailed description with respect to a reward service, review for the reward service, and information regarding reward service provision conditions.

If the service provider 100 wishes to expose reward service information for each unit dividing a played time of certain media contents, the reward service information may include particular information. For example, a service provider 100 selling tour products may advertise tour products only when a screen associated with a rest area is output on a certain soap opera. In this case, the service provider 100 transmits a title of the soap opera, a detailed description and review of tour products, service providing conditions, and information indicating that the advertisement is only for a certain time of a total playback time of the soap opera to the platform server 200.

The platform server 200 links received reward service information with certain media contents. This is performed to transmit the reward service information linking with certain media contents to a user. For example, the platform server 200 may link such that advertisements for golf products are displayed while a golf game is being rebroadcasted. In addition, the link may be achieved in time units dividing a playback time of certain media contents.

The platform server 200 may link such that information about tour products are displayed only when a screen associated with a rest area is output for a playback time of a soap opera.

The reward service information may be displayed on the user device 300, to be included in a playback screen of favorite media contents or an initial menu with respect to the media contents.

The reward service information is displayed when the user so desires. However, the present invention is not limited thereto. For example, reward service information may be displayed if the user should check-in. For example, if the user checks-in golf rebroadcast, a rebroadcast screen is divided and information about golf products are displayed. The reward service information may be displayed regardless of a user request. For example, reward service information regarding golf products is displayed at a lower end of a screen in a golf rebroadcast with a sliding caption.

In the present invention, a condition of a reward service is check-in information. That is, so as to obtain a use right of a reward service, the user should check-in certain media contents according to a providing condition of the reward service. For example, such check-in may be achieved in a method pushing a ‘Check-in’ button on a TV remote controller when an Internet TV is a user device. When a smart phone is a user device, the check-input may be configured by a method clicking a ‘Check-in’ icon on a liquid crystal display screen.

Next, the platform server 200 receives check-in information and determines whether a providing condition of corresponding reward service is satisfied. When the providing condition of corresponding reward service is satisfied, the platform server 200 grants a use right with respect to a reward service. Such a use right may be granted in a manner that transmits a coupon allowing the user to use a corresponding reward service. For example, an electronic coupon is transmitted by an e-mail, a paper coupon is transmitted by mail, or a bar code type mobile coupon may be transmitted. However, the present invention is not limited to granting a use right by a coupon. For example, paid media contents may be used without charge in an Internet TV.

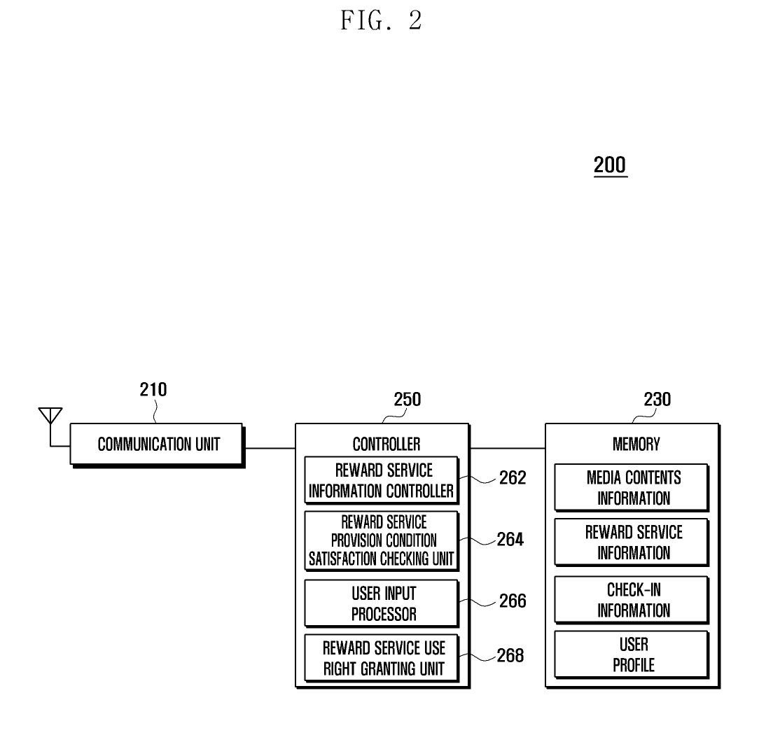

FIG. 2 illustrates a platform server 200 providing a reward service linked with media contents according to an embodiment of the present invention. Referring to FIG. 2, the platform server 200 includes a communication unit 210, a memory 230, and a controller 250.

The controller 250 includes a reward service information controller 262, a reward service provision condition satisfaction determining unit 264, a user input processor 266, and a reward service use right granting unit 268. However, this configuration is to assist in the understanding of the present invention, and all related functions may be performed by a controller 250.

The communication unit 210 performs transmitting and receiving information. The platform server receives reward service information from a service provider through the communication unit 210, and transmits reward service information to the user. The communication unit 210 also receives a request or check-in information from the user.

The memory 230 stores media contents information, reward service information, check-in information of the user or a profile of the user. The check-in information indicates how many times the user checks-in certain media contents. The profile of the user may include a portable phone number for transmitting a coupon.

The controller 250 controls such that the reward service information is linked with certain media contents, collects check-in information, and determines whether a reward service provision condition is satisfied. When the reward service provision condition is satisfied, the controller 250 performs a function giving a user right with respect to a reward service.

Specifically, the reward service information controller 262 controls such that reward service information is included in a playback screen or an initial menu with respect to media contents to be transmitted. The user input processor 266 performs a function for processing transmission request of reward service information received through the communication unit 210, and granting request of use right of check-in information or a reward service. The reward service provision condition satisfaction determining unit 264 checks whether a reward service provision condition is satisfied based on collected check-in information. When the reward service provision condition is satisfied, the reward service use right granting unit 268 grants a use right to the user.

For example, when a reward service provided from the service provider 100 is a golf tournament viewing ticket, and a providing condition is ten (10) check-ins with respect to a golf lesson program, the controller 250 includes information with respect to the reward service in a golf lesson program and transmits the information to the user device 300. When the check-in of the user is 10 times, the controller 150 may transmit a mobile coupon capable of viewing the golf tournament.

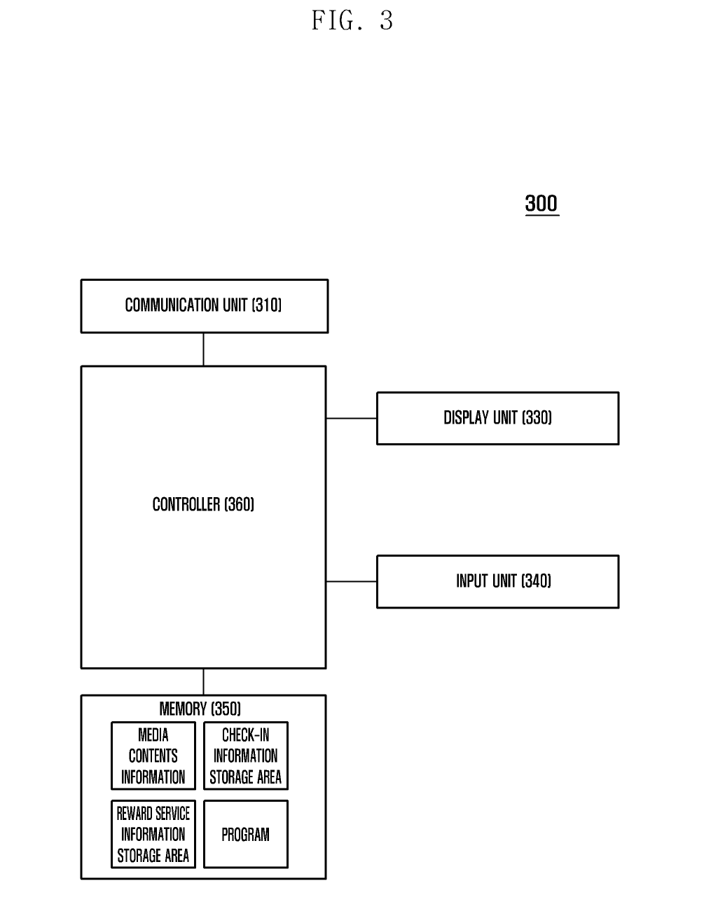

FIG. 3 illustrates a device for obtaining a reward service linked with media contents according to an embodiment of the present invention. Referring to FIG. 3, the user device 300 includes a communication unit 310, a display unit 330, an input unit 340, a memory 350, and a controller 360.

The communication unit 310 performs a function transmitting and receiving information. The user device 300 receives reward service information from the platform server 200 through the communication unit 310 and transmits check-in information. The user device 300 transmits a transmission request of reward service information or a granting request of a use right of a reward service through the communication unit 310, which receives information through wired/wireless channels and outputs the information to the controller 360. The communication unit 310 may transmit data output from the controller 360 through wired/wireless channels.

The display unit 330 may be a liquid crystal display, an Organic Light Emitting Device (OLED), or a passive type OLED. The display unit visibly provides a menu of the user device 300, media contents, reward service information and other information to the user. The display unit 330 performs a function outputting a menu screen, a media contents playback screen, and a reward service information display screen.

The input unit 340 performs a function of inputting check-in information. A transmission request of reward service information or a granting request of a use right of a reward service is input by the input unit 340, which receives input of a key operation of the user for controlling the user device 300 to generate an input signal and transfers the input signal to the controller 360. The input unit 340 may be configured by a keypad including numeral keys or arrow keys. The input unit 340 may be included in a device separate from a user device 300 such as a remote controller for operating an Internet TV.

The memory 350 stores programs and data necessary for an operation of the use device 300 and is divided into a program area and a data area. The program area may store a program controlling an overall operation of the user device 300, an operating system booting the user device 300, an application program necessary for playing media contents, and an application program necessary for other option functions of the user device 300 such as a voice playing function, and an image or moving image playing function. The data area stores information created according to use of the user device, which may store media contents information, reward service information, and check-in information.

The controller 360 performs a processing function such that the reward service information received through the communication unit 310 may be output on the display unit 330. In this case, the controller 360 may include and display reward service information in a screen of media contents or a menu with respect to the media contents output on the display unit 330. The controller 360 receives a signal of the input unit 340, transmits check-in information to the platform server 200 through the communication unit 310, and stores the information in the memory 350.

The controller 360 may determine whether a reward service obtaining condition is satisfied based on the check-in information. When the reward service obtaining condition is satisfied, the controller 360 may process the display unit 330 to output a message an obtain condition satisfaction. The controller 360 receives a signal of the input unit 340 and performs a function for transmitting a transmission request of reward service information or a granting request of a use right of a reward service through the communication unit 310.

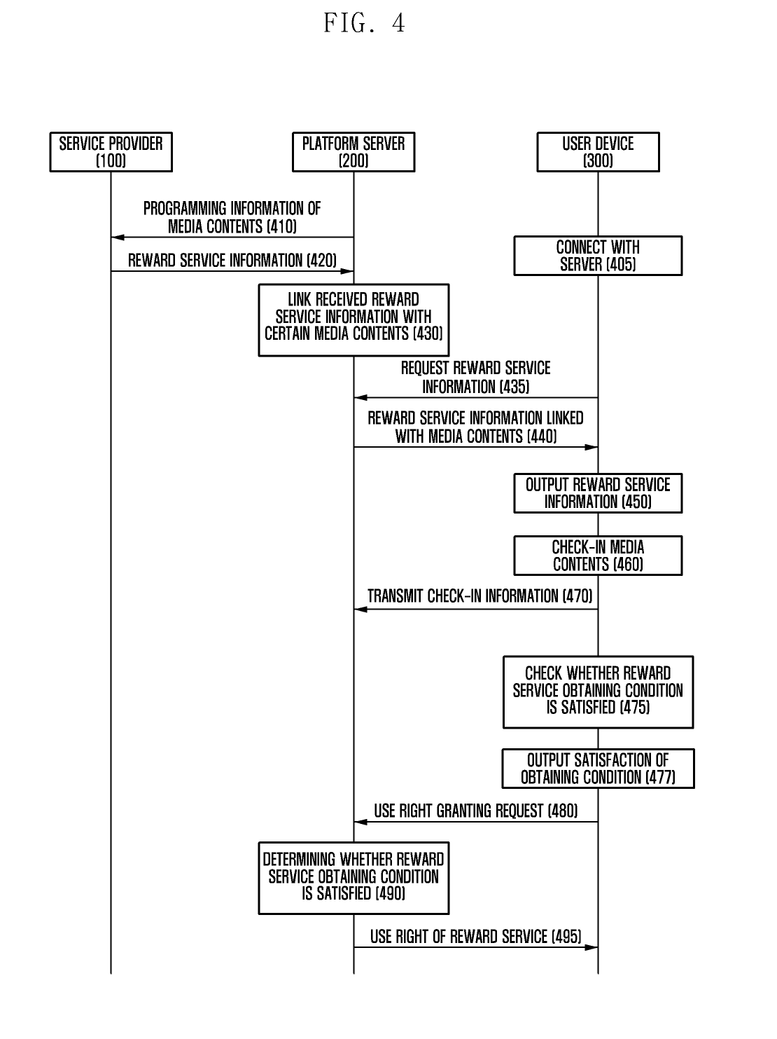

FIG. 4 illustrates a method for providing and obtaining a reward service linked with media contents according to an embodiment of the present invention. In FIG. 4, a service provider 100, a platform server 200, and a user 300 are the subjects.

The platform server 200 transmits programming information of media contents to service providers 100 in step 410, and receives reward service information in step 420. The foregoing information is transmitted/received through a communication unit 210, and may include a detailed description of a reward service, reviews with respect to the reward service, information about a reward service provision condition, and a title of media contents to be linked.

The controller 250 of the platform server 200 then links the received reward service information with certain media contents in step 430. This is performed to transmit the reward service information linked with certain media contents. The controller 250 includes the reward service information in a media contents screen played by the user device 300 or an initial screen with respect to media contents and transmits the information. In addition, the controller 250 may link the reward service information by time units dividing a played time of certain media contents.

A user device 300 connects with a platform server 200 through a wired/wireless network and becomes a state capable of transmitting/receiving information in step 405. If the user inputs a transmission request of reward service information through an input unit 340, the controller 360 of the user device 300 transmits a transmission request of the reward service information through the communication unit 310 when the user wishes in step 435. However, because the present invention is not limited thereto, step 435 may be omitted.

The communication unit 310 of the user device 300 receives reward service information from the platform server 200 in step 440. Although FIG. 4 illustrates that step 440 is performed after step 435, the present invention is not limited thereto. That is, step 440 may be performed prior to step 435, and the user device 300 may previously receive the reward service information but displayed it when there is a request.

The display unit 330 outputs reward service information in step 450. In this case, the controller 360 may include and display the reward service information in a media contents screen played on the display unit 330 or a menu screen with respect to the media contents.

Step 460 of FIG. 4 involves checking-in the media contents. If the user checks-in the media contents through the input unit 340 of the user device 300, the check-in information is stored in the memory 350 of the user device 300. According to the present invention, linked reward service information is displayed if a user should check-in media contents. In this case, step 460 may unite with step 435. Subsequently, the controller 360 transmits check-in information to the platform server 200 in step 470.

The controller 360 of the user device 300 determines whether a reward service obtaining condition is satisfied based on the check-in information in step 475. When the reward service obtaining condition is satisfied, the controller 360 may process such that a message with respect to satisfaction of the obtaining condition is output in step 477. Step 475 and step 477 may be omitted.

Step 480 of FIG. 4 involves requesting a use right of a reward service. If the user inputs a use right granting request of the reward service through the input unit 340, the controller 360 of the user device 300 transmits the use right granting request of the reward service to the platform server 200 through a communication unit 310. Step 480 involves receiving use right granting of the reward service only when the user so desires. However, the present invention is not limited thereto, step 480 may be omitted.

The controller 250 of the platform server 200 determines whether a reward service provision condition is satisfied in step 490. When the reward service provision condition is satisfied, the controller 250 grants a use right of the reward service to the user in step 495. For example, when the provision condition of the reward service is satisfied, the controller 250 may control the communication unit 210 to transmit a mobile coupon using user portable terminal information of a memory.

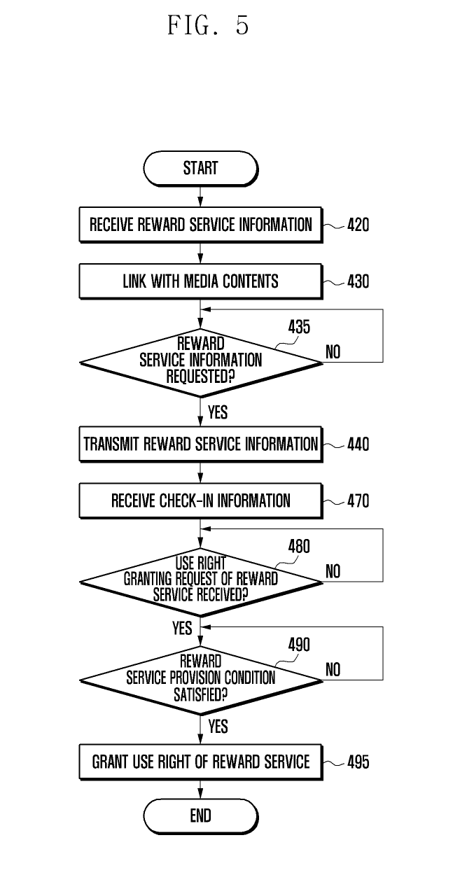

FIG. 5 illustrates a procedure of providing a reward service linked with media contents by a platform server. The steps of FIG. 5 that are the same as those of FIG. 4 use the same reference numbers.

A communication unit 210 receives reward service information from a service provider 100 in step 420. The controller 250 links the received reward service information with certain media contents in step 430. Therefore, the reward service information is linked with the certain media contents that are transmitted to the user. The controller 250 may include and display the reward service information in a media contents screen played by the user device or an initial screen with respect to the media contents.

If the communication unit 210 receives transmission request of the reward service information from the user device 300 in step 435, the controller 250 controls the communication unit 210 to transmit the reward service information to the user device 300 in step 440. If not, step 435 is repeated. As illustrated above, step 435 involves transmitting reward service information only when the user so desires. Because the present invention is not limited thereto, step 435 may be omitted.

The communication unit 210 receives check-in information from the user device 300 in step 470. Although FIG. 5 illustrates step 470 after step 440, the present invention is not limited thereto. That is, the communication unit 210 may always receive check-in information when the user checks-in, regardless of the reward service.

The communication unit 210 receives a use right granting request of a reward service from the user device 300 in step 480. As illustrated above, step 480 involves providing the reward service only when the user 300 so desires. Because the present invention is not limited thereto, step 480 may be omitted. When the condition is satisfied regardless of the user request, a use right of a reward service may be automatically granted.

The controller 250 determines whether a reward service provision condition is satisfied in step 490. When the reward service provision condition is satisfied, the controller 250 controls the communication unit 210 to transmit a reward service use coupon to the user in step 495. When the reward service provision condition is not satisfied, step 490 is repeated.

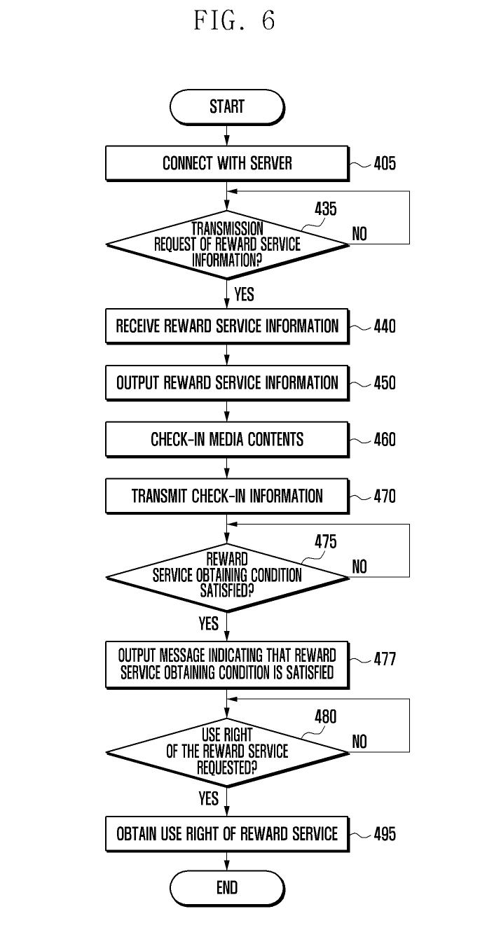

FIG. 6 illustrates a procedure of obtaining a reward service linked with media contents by a user device 300. The steps in FIG. 6 that are the same as those of FIG. 4 use the same reference numerals.

A user device 300 connects with a platform server 200 through a wired/wireless network in step 405. If the user inputs a transmission request of reward service information through the input unit 340, the controller 360 of the user device 300 sends the transmission request of the reward service information through the communication unit 310 in step 435. If the transmission request is inputted, step 435 is repeated. As illustrated above, step 435 involves receiving reward service information only when the user so desires. Because the present invention is not limited thereto, step 435 may be omitted.

The communication unit 310 receives reward service information from the platform server 200 in step 440. Although FIG. 4 illustrates that step 440 is performed after step 435, the present invention is not limited thereto. That is, step 440 may be performed before step 435. When reward service information is displayed only when the reward service information is previously received by the user device 300 and is requested.

The display unit 330 outputs reward service information in step 450. In this case, the controller 360 controls such that the reward service information is included and displayed in a media contents screen played on the display unit 330 or a menu screen with respect to the media contents.

Step 460 of FIG. 6 involves checking-in the media contents by the user in step 460. If the user checks-in the media contents through the input unit 340, the check-in information is stored in the memory 350 of the user device 300. Herein, reward service information that the user should check-in may be displayed. In this case, step 460 may unite with step 435. The controller 360 then transmits the check-in information to the platform server 200 in step 470.

The controller 360 of the user device 300 determines whether a reward service obtaining condition is satisfied based on the check-in information in step 475. If the reward service obtaining condition is satisfied, the controller 360 may output a message indicating that the reward service obtaining condition is satisfied through the display unit 330 in step 477. If the reward service obtaining condition is not satisfied, step 475 is repeated.

Step 480 involves requesting a use right of the reward service in step 480. If the user inputs an obtaining request of a use right of the reward service through the input unit 340 at step 480, the controller 360 controls the communication unit 310 to transmit the request to the platform server 200. Step 480 involves obtaining a use right of the reward service only when the user 300 so desires. However, because the present invention is not limited thereto, step 435 may be omitted. The communication unit 310 receives use right information from the platform server 200, and the controller 360 processes the received use right information to obtain the use right in step 495.

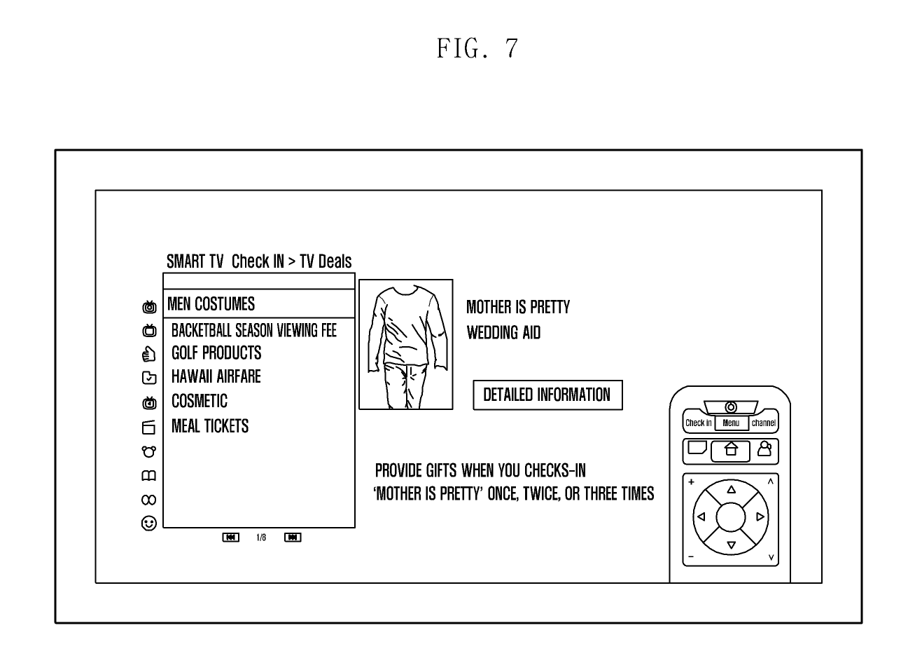

FIG. 7 illustrates a method displaying a reward service linked with media contents. For example, if the user clicks a menu of “TV Deals” from an

Internet TV, reward service information is displayed. To launch new products, process residual stocks, or provide a regular discount, advertisers may provide a reward service. For example, if the user checks-in first, second, and third instances of a soap opera advertising clothes, the advertisers may provide a discount coupon for the clothes. As another embodiment, a basketball association may induce watching rebroadcast of a basketball game to popularize the game. In this case, if the user checks-in a tenth one of a basketball rebroadcast and a first one of documents with respect to the basketball, the advertisers may provide a season admission ticket.

The method of FIG. 7 may involve obtaining a reward service linked with media contents using check-in information authenticating that certain media contents are being played as a condition.

Further, the present invention provides a service that the user can use as a reward to induce check-in. Through this, user utility with respect to media contents may be improved and user information of the media contents can be collected.

Although embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method for providing a reward service linked with media contents, the method comprising:
transmitting reward service information linked with the media contents to a user device;
receiving check-in information authenticating that certain media contents are being played from the user device;
determining whether a provision condition of the reward service is satisfied by the user device; and
granting a use right with respect to the reward service to the user device when the provision condition of the reward service is satisfied, wherein the provision condition of the reward service is reception of the check-in information.

2. The method of claim 1, further comprising:
receiving reward service information to be linked with the certain media contents from a service provider; and
linking the reward service information received from the service provider with the certain media contents, before transmitting the reward service information.

3. The method of claim 2, wherein the reward service information is linked with the certain media contents by time units dividing a played time of the certain media contents.

4. The method of claim 1, wherein transmitting the reward service information comprises including and transmitting the reward service information in a media contents playback screen or menu screen of the user device.

5. The method of claim 1, further comprising receiving a transmission request of the reward service information from the user device before transmitting the reward service information.

6. The method of claim 1, further comprising receiving a granting request of a use right of the reward service from the user device before determining whether a provision condition of the reward service is satisfied.

7. A platform server for providing a reward service linked with media contents, the server comprising:
a communication unit which transmits reward service information linked with media contents and receives check-in information authenticating that the media contents are being played;
a memory which stores the reward service information, the check-in information, and a profile of a user device; and
a controller which controls such that the reward service information is transmitted to the user device, collects the check-in information, determines whether the user device satisfies a provision condition of the reward service, and grants a use right with respect to the reward service to the user device when the user device satisfies the provision condition of the reward service,
wherein the provision condition of the reward service is reception of the check-in information.

8. The platform server of claim 7, wherein the communication unit receives reward service information to be linked with the media contents from a service provider, and the controller links the reward service information received from the service provider with the media contents before transmitting the reward service information.

9. The platform server of claim 8, wherein the controller links the reward service information with the media contents by time units dividing a played time of the media contents.

10. The platform server of claim 7, wherein the controller controls such that the reward service information is included in a media contents playback screen or menu screen of the user device and is transmitted to the user device.

11. The platform server of claim 7, wherein the communication unit receives a transmission request of the reward service information or a granting request of a use right of the reward service from the user device, and the controller processes the request.

12. A method for obtaining a reward service linked with media contents, the method comprising:
receiving and displaying reward service information linked with the media contents;
receiving and transmitting check-in information authenticating that certain media contents are being played to a platform server; and
receiving a use right with the reward service from the platform server when an obtaining condition of the reward service is satisfied,
wherein the obtaining condition of the reward service is satisfied.

13. The method of claim 12, wherein receiving and displaying reward service information comprises including and transmitting the reward service information in a media contents playback screen or menu screen.

14. The method of claim 12, further comprising transmitting a transmission request of the reward service information receiving and displaying the reward service information.

15. The method of claim 12, further comprising transmitting a granting request of the use right of the reward service before receiving a use right.

16. The method of claim 12, further comprising:
checking whether an obtaining condition of the reward service is satisfied, and
displaying that the obtaining condition of the reward service is satisfied, before receiving a use right.

17. A user device for obtaining a reward service linked with media contents, the device comprising:
a communication unit which transmits reward service information linked with the media contents and receives check-in information authenticating that the media contents are being played;
a display unit which displays the reward service information;
an input unit which inputs the check-in information;
a memory which stores the reward service information and the check-in information; and
a controller which controls such that the reward service information is displayed, and obtains a use right with respect to the reward service from the platform server when an obtaining condition of the reward service is satisfied,
wherein obtaining the condition of the reward service requires transmission of the check-in information.

18. The user device of claim 17, wherein the controller controls such that the reward service information is included in and displayed on a media contents playback screen or menu screen of the user device.

19. The user device of claim 17, wherein the communication unit receives a transmission request of the reward service information or a granting request of a use right of the reward service, and the controller controls such that the request is transmitted to the platform server.

20. The user device of claim 17, wherein the controller controls such that satisfaction of the obtaining condition of the reward service is displayed when the obtaining condition of the reward service is satisfied.
